(19) United States
(12) Patent Application Publication
(10) Pub. No.: US 2009/0017337 A1
(43) Pub. Date: Jan. 15, 2009

(54) FREEZE TOLERANT PRESSURE SENSOR

(76) Inventors: Dirk Wexel, Mainz (DE); Joseph Gerzseny, Spencerport, NY (US)

Correspondence Address: FRASER CLEMENS MARTIN & MILLER LLC, 28366 KENSINGTON LANE, PERRYSBURG, OH, 43551-4163, US

(21) Appl. No.: 11/775,583

(22) Filed: Jul. 10, 2007

(51) Int. Cl. H01M 8/00; G01L 13/02

(52) U.S. Cl. 429/12; 73/716

(57) ABSTRACT

A pressure sensor for use in a fuel cell is disclosed having a first end and a second end. A cavity is provided at a second end of the sensor and a membrane is disposed on the second end of the sensor enclosing a fluid within the cavity. The membrane and the fluid cooperate to transfer a pressure from the fuel cell to a means for transforming the pressure into a signal. The pressure sensor adapted to militate against a false pressure reading.

### FIELD OF THE INVENTION

The invention relates to a pressure sensor and, more particularly, to a fuel cell pressure sensor adapted to sense a pressure within a flow channel of the fuel cell.

### BACKGROUND OF THE INVENTION

Fuel cell systems are increasingly being used as a power source in a wide variety of applications. Fuel cell systems have been proposed for use in power consumers such as vehicles as a replacement for internal combustion engines, for example. Such a system is disclosed in commonly owned U.S. patent application Ser. No. 10/418,536, hereby incorporated herein by reference in its entirety. Fuel cells may also be used as stationary electric power plants in buildings and residences, as portable power in video cameras, computers, and the like. Typically, the fuel cells generate electricity used to charge batteries or to provide power for an electric motor.

Fuel cells are electrochemical devices which directly combine a fuel such as hydrogen and an oxidant such as oxygen to produce electricity. Other fuels can be used such as natural gas, methanol, gasoline, and coal-derived synthetic fuels, for example.

The basic process employed by a fuel cell is efficient, substantially pollution-free, quiet, free from moving parts (other than an air compressor, cooling fans, pumps and actuators), and may be constructed to leave only heat and water as by-products. The term “fuel cell” is typically used to refer to either a single cell or a plurality of cells depending upon the context in which it is used. The plurality of cells is typically bundled together and arranged to form a stack with the plurality of cells commonly arranged in electrical series. Since single fuel cells can be assembled into stacks of varying sizes, systems can be designed to produce a desired energy output level providing flexibility of design for different applications.

Different fuel cell types can be provided such as phosphoric acid, alkaline, molten carbonate, solid oxide, and proton exchange membrane (PEM), for example. The basic components of a PEM-type fuel cell are two electrodes separated by a polymer membrane electrolyte. Each electrode is coated on one side with a thin catalyst layer. The electrodes, catalyst, and membrane together form a membrane electrode assembly (MEA).

In a typical PEM-type fuel cell, the MEA is sandwiched between “anode” and “cathode” diffusion mediums (hereinafter “DM's”) or diffusion layers that are formed from a resilient, conductive, and gas permeable material such as carbon fabric or paper. The DM's serve as the primary current collectors for the anode and cathode as well as provide mechanical support for the MEA. The DM's and MEA are pressed between a pair of electronically conductive plates which serve as secondary current collectors for collecting the current from the primary current collectors. The plates conduct current between adjacent cells internally of the stack in the case of bipolar plates and conduct current externally of the stack (in the case of monopolar plates at the end of the stack).

The secondary current collector plates each contain at least one active region that distributes the gaseous reactants over the major faces of the anode and cathode. These active regions, also known as flow fields, typically include a plurality of lands which engage the primary current collector and define a plurality of grooves or flow channels therebetween. In a hydrogen fuel cell, the channels supply the hydrogen and the oxygen to the electrodes on either side of the PEM from an intake manifold. In particular, the hydrogen flows through the channels to the anode where the catalyst promotes separation into protons and electrons. On the opposite side of the PEM, the oxygen flows through the channels to the cathode where the oxygen attracts the hydrogen protons through the PEM. The electrons are captured as useful energy through an external circuit and are combined with the protons and oxygen to produce water vapor at the cathode side.

The flow of the reactants through the channels must be precisely controlled to maintain the optimum performance of the fuel cell. The flows are typically monitored by one or more pressure sensors in communication with the flow paths of the reactants. False pressure readings by the sensors can result in a low reactant pressure within the fuel cell. Low reactant pressures can lead to an insufficient supply of the reactants needed to produce the required electrical output. Alternatively, false pressure readings by the sensors can result in a high reactant pressure that can permanently damage the fuel cell. Known pressure sensors are susceptible to such false readings when the fuel cell is operating at a sub-zero temperature, or a temperature below the freezing point of water. Such temperatures may cause the water vapor within the fuel cell to condense and freeze. The frozen water condensate can cause false readings in the known pressure sensors when the frozen condensate blocks the communication between the reactant flow path and the sensor.

It would be desirable to develop a pressure sensor that militates against a false pressure reading within a fuel cell under operating conditions below the freezing point of water.

### SUMMARY OF THE INVENTION

Compatible and attuned with the present invention, a pressure sensor that militates against a false pressure reading within a fuel cell under operating conditions below the freezing point of water has surprisingly been discovered.

In one embodiment, a pressure sensor for use in a fuel cell comprises a body having a first end and a second end and including a cavity formed therein, the cavity adapted to contain a first fluid; and a membrane disposed at the second end of the body to seal off the cavity, wherein a pressure of a second fluid in communication with the membrane is transferred through the membrane to the first fluid.

In another embodiment, a fuel cell comprises at least one pressure sensor including a body having a first end and a second end and including a cavity formed therein, the cavity adapted to contain a first fluid; at least one flow channel adapted to provide a flow path for a second fluid, the second fluid being one of a fuel, an oxidant, and a coolant; a communication path disposed between the flow channel and the pressure sensor, the communication path adapted to contain the first fluid and including at least one membrane disposed therein, the membrane separating the first fluid from the second fluid, wherein a pressure of the second fluid is transferred through the membrane and the first fluid to the pressure sensor.

In another embodiment, a fuel cell stack comprises at least one pressure sensor including a body having a first end and a second end and including a cavity formed therein, the cavity adapted to contain a first fluid, and a membrane disposed at the second end of the body to seal off the cavity, wherein a pressure of a second fluid in communication with the membrane is transferred through the membrane to the first fluid; and at least one fuel cell including at least one flow channel adapted to provide a flow path for the second fluid, the second fluid being one of a fuel, an oxidant, and a coolant.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross sectional side view of a known pressure sensor;

FIG. 2 is a cross sectional side view of the pressure sensor illustrated in FIG. 1 showing a frozen water droplet interfering with the operation thereof;

FIG. 3 is a cross sectional side view of a pressure sensor in accordance with an embodiment of the invention;

FIG. 4 is a cross sectional side view of the pressure sensor illustrated in FIG. 3 showing a frozen water droplet adjacent thereto; and

FIG. 5 is a cross sectional side view of a pressure sensor in accordance with another embodiment of the invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

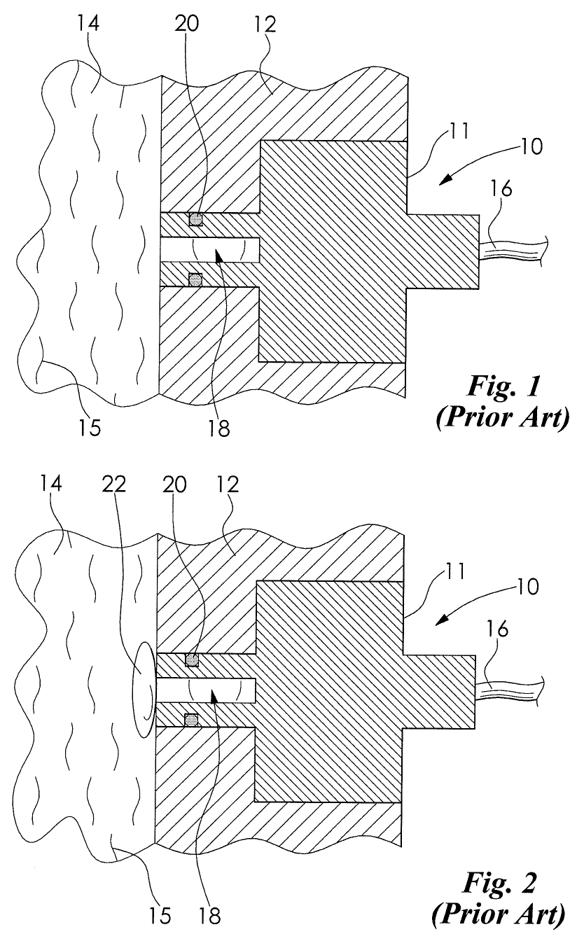

FIG. 1 shows a prior art pressure sensor 10 having a body 11 disposed in a structural member of a fuel cell 12 adjacent a fluid flow channel 14. It should be understood that a fluid 15 within the flow channel 14 can include a fuel supplied to an anode plate, an oxidant supplied to a cathode plate, and a coolant that circulates therein to assist in maintaining a desired temperature of the fuel cell 12. Accordingly, the pressure sensor 10 can be used to monitor a pressure of the fluid 15 in a fuel flow channel, an oxidant flow channel, and a coolant flow channel. It should be understood the fluid flow channel 14 can be any of several flow channels typically found in a fuel cell including, but not limited to, an inlet manifold, an outlet manifold, and a flow field channel formed on the anode plate and the cathode plate. Further, it should be understood that the term “fluid” includes a liquid and a gas.

One end of the pressure sensor 10 includes a connection 16 to a measuring device (not shown). An opposite end of the pressure sensor 10 includes a communication path 18 formed therein and in fluid communication with the flow channel 14. An o-ring 20 is provided between the pressure sensor 10 and the fuel cell 12 to provide a substantially fluid tight seal therebetween. It should be understood that other sealing means can be used as desired to achieve the substantially fluid tight seal.

In operation the fluid 15 in the flow channel 14 is in communication with the pressure sensor 10 through the communication path 18. The pressure sensor 10 includes a transducer (not shown) within the body 11 that converts a pressure of the fluid 15 into a representative electrical signal. The electrical signal is then relayed through the connection 16 to the measuring device. The measuring device interprets the electrical signal as a pressure reading of the fluid 15. The measuring device cooperates with other control devices (not shown) such as a pressure regulator that adjust a flow of the fluid 15 in the flow channel 14 to maintain a desired fluid pressure therein.

The fluid 15 within the flow channel 14 is often a gas that includes water vapor. At operating temperatures below the freezing point of water, droplets of water condensate can form and freeze on a surface of the flow channel 14. As shown in FIG. 2, a frozen water droplet 22 can form in the area of the communication path 18 and be of such a size to block the communication path 18 of the pressure sensor 10. The blocked communication path 18 prevents the pressure sensor 10 from communicating with the fluid 15 in the flow channel 14, resulting in a false pressure reading. The false pressure reading can cause the pressure of the fluid 15 within the flow channel 14 to fall below or rise above the desired fluid pressure. A low pressure within the flow channel 14 can result in a reduced power output of the fuel cell 12. A high pressure within the flow channel 14 can result in damage to the fuel cell 12, thereby affecting an operation thereof.

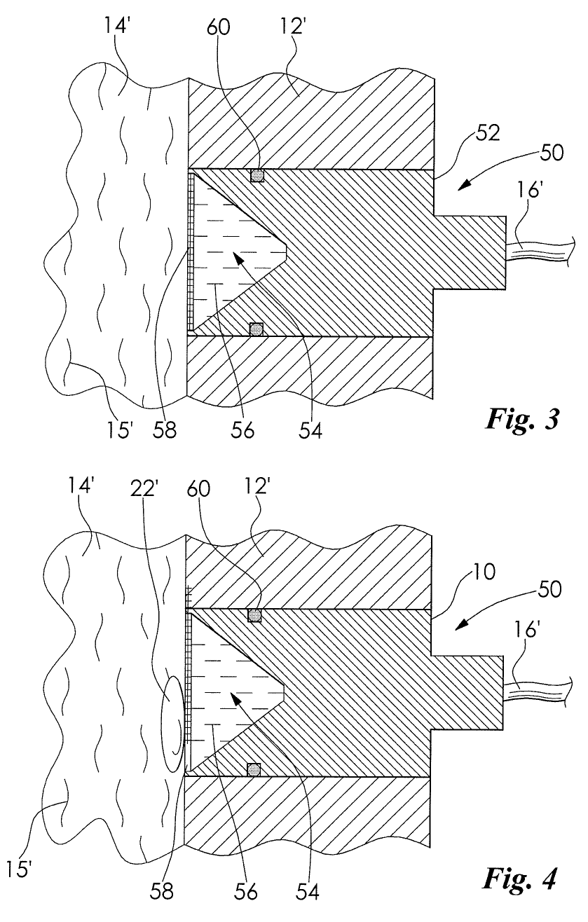

FIGS. 3 and 4 illustrate a pressure sensor 50 in accordance with an embodiment of the invention. Like structure repeated from FIGS. 1 and 2 includes the same reference numeral and a prime symbol (′). The pressure sensor 50 has a body 52 that is disposed in a structural member of a fuel cell 12′ adjacent a fluid flow channel 14′. It should be understood that a fluid 15′ within the flow channel 14′ can include a fuel supplied to an anode plate, an oxidant supplied to a cathode plate, and a coolant that circulates therein to assist in maintaining a desired temperature of the fuel cell 12′. Accordingly, the pressure sensor 50 can be used to monitor a pressure of the fluid 15′ in a fuel flow channel, an oxidant flow channel, and a coolant flow channel. It should be understood the fluid flow channel 14′ can be any of several flow channels typically found in a fuel cell including an inlet manifold, an outlet manifold, and a flow field channel formed on the anode plate and the cathode plate.

One end of the pressure sensor 50 includes a connection 16′ to a measuring device (not shown). An opposite end of the pressure sensor 50 includes a substantially conical shaped cavity 54 formed therein. It should be understood that the cavity 54 may be cubical, cylindrical, or otherwise shaped, as desired. A fluid 56 is provided in the cavity 54. A membrane 58 is disposed on the body 52 to seal off the cavity 54 and seal the fluid 56 therein. In the embodiment shown, the fluid 56 is a freeze-resistant liquid such as an ethylene glycol and water solution that has a freeze point lower than water, and the low temperature operating conditions of the fuel cell 12′. The low freezing point of the freeze-resistant liquid prevents the freeze-resistant liquid from freezing while the fuel cell 12′ is operating at such low temperatures. It should be understood that other fluids can be used as desired. An o-ring 60 is provided between the pressure sensor 50 and the fuel cell 12′ to provide a substantially fluid tight seal therebetween. It should be understood that other sealing means can be used as desired to achieve the substantially fluid tight seal.

In operation, the fluid 15′ in the flow channel 14′ is in communication with the membrane 58. The fluid 15′ exerts a pressure on the membrane 58 which is transferred to the fluid 56. The membrane 58 is adapted to cooperate with the fluid 56 to communicate the pressure of the fluid 15′ to a transducer (not shown) within the body 52 of the pressure sensor 50. The transducer converts the pressure of the fluid 15′ into a representative electrical signal. The electrical signal is then relayed through the connection 16′ to a measuring device (not shown). The measuring device interprets the electrical signal as a pressure reading of the fluid 15′. The measuring device then cooperates with other control devices (not shown) such as a pressure regulator that adjust a flow of the fluid 15′ in the flow channel 14′ to maintain the desired fluid pressure therein. It is understood that other systems could be used to read, convert, and relay a pressure reading in place of the electrical system such as pneumatic, for example.

As discussed above, the droplets of water condensate can form within the flow channel 14′ and freeze on a surface thereof. FIG. 4 shows a frozen water droplet 22′ that has formed within the flow channel 14′ and adjacent the membrane 58. A surface area covered by the water droplet 22′ is less than a surface area of the membrane 58. The presence of the frozen water droplet 22′ does not completely block the communication between the flow channel 14′ and the transducer within the body 52 of the pressure sensor 50. The membrane 58 provides a sufficiently large surface area for the communication of the pressure of the fluid 15′ when the frozen water droplet 22′ forms adjacent the membrane 58. The pressure sensor 50 militates against the frozen water droplet 22′ causing a false pressure reading. By minimizing a likelihood of false pressure readings, an optimum performance of the fuel cell 12′ can be maintained.

The blockage of the communication between the flow channel 14′ and the transducer within the body 52 of the pressure sensor 50 can lead to a low pressure within the flow channel 14′ or a high pressure within the flow channel 14′. Either condition can result in a shutting down of the production of electricity by the fuel cell 12′. The loss of the electrical production from the fuel cell 12′ is often referred to as a “walk home failure”. A vehicle using the electrical output from the fuel cell 12′ to power an electrical drive motor will be rendered inoperable upon such loss of electrical production. The pressure sensor 50 militates against fuel cell shutdown and the inconvenience caused to a person relying on the continued uninterrupted electrical supply from the fuel cell 12′.

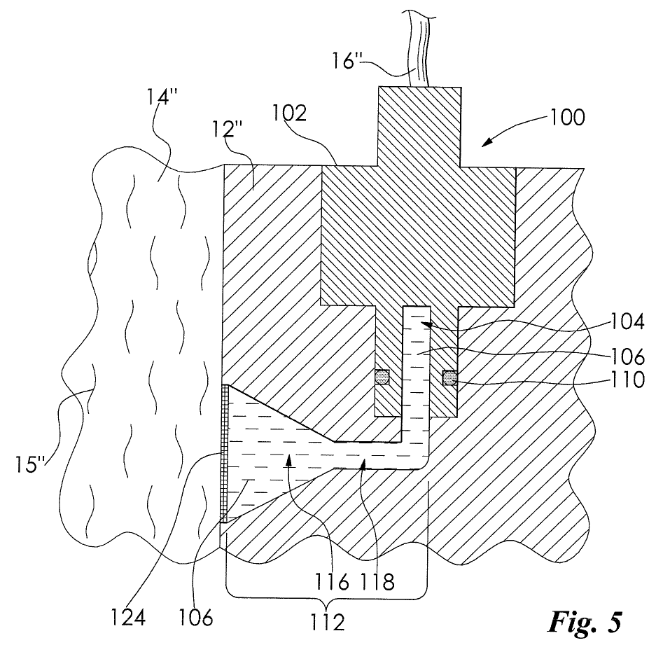

The pressure sensor 50 shown in FIGS. 3 and 4 is disposed within the fuel cell to place the membrane 58 in contact with the fluid 15′ in the flow channel 14′. However, as shown in FIG. 5, a cooperating communication path can be provided to the fuel cell 12′ that allows the pressure sensor to be remotely located from the flow channel 14′. Like structure repeated from FIGS. 1 and 2 includes the same reference numeral and a double prime symbol (″). In FIG. 5 a pressure sensor 100 is remotely located from the flow channel 14″. At one end of the pressure sensor 100, a connection 16″ to a measuring device (not shown) is provided. An opposite end of the pressure sensor 100 includes a cylindrically shaped cavity 104 formed therein. It should be understood that the cavity 104 may be cubical, conical, or otherwise shaped, as desired. An o-ring 110 is provided between the pressure sensor 100 and the fuel cell 12″ to provide a substantially fluid tight seal therebetween. It should be understood that other sealing means as desired can be used to achieve the substantially fluid tight seal.

A communication path 112 is formed within the structural member of the fuel cell 12″. The communication path 112 is a channel or conduit formed in a selected portion of the fuel cell 12″. The communication path 112 has a first section 116 having a substantially conically shape and a second section 118 having a substantially constant cross-sectional shape. The fluid 106 fills the communication path 112 and the cavity 104 in the pressure sensor 100. In the embodiment shown, the fluid 106 is a freeze-resistant liquid such as an ethylene glycol and water solution that has a freeze point lower than water, and the low temperature operating conditions of the fuel cell 12″. The low freezing point of the freeze-resistant liquid prevents the freeze-resistant liquid from freezing while the fuel cell 12″ is operating at such low temperatures. It should be understood that other fluids can be used as desired. A membrane 124 is disposed on the fuel cell 12″ to seal off the communication path 112 and seal the fluid 106 therein.

In operation, the pressure sensor 100 shown in FIG. 5 is disposed in the fuel cell 12″. The fluid 15″ flowing in the channel 14″ is in contact with the membrane 124 of the communication path 112. The fluid 15″ exerts a pressure on the first membrane 124. The first membrane 124 is adapted to cooperate with the fluid 106 to communicate the pressure exerted by the fluid 15″ to a transducer (not shown) within the body 102 of the pressure sensor 100. It should be understood that the fluid filled communication path 112 between the flow channel 14″ and the pressure sensor 100 can have other configurations. It should also be understood that the pressure sensor 100 can be located outside of the fuel cell 12″ wherein the communication path 112 includes a hose or pipe, for example, extending outwardly of the fuel cell and in communication with the cavity 104 of the pressure sensor 100. The remaining structure and use is substantially the same as described above for the embodiment shown in FIGS. 3 and 4.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A pressure sensor for use in a fuel cell, the pressure sensor comprising:
a body having a first end and a second end and including a cavity formed therein, the cavity adapted to contain a first fluid; and
a membrane disposed at the second end of the body to seal off the cavity, wherein a pressure of a second fluid in communication with the membrane is transferred through the membrane to the first fluid.

2. The pressure sensor according to claim 1, wherein the cavity has one of a substantially conical shape, cubical shape, and cylindrical shape.

3. The pressure sensor according to claim 1, wherein the first fluid is a liquid having a freezing point at a temperature lower than a freezing point of water.

4. The pressure sensor according to claim 1, wherein the first fluid is a liquid having a freezing point at a temperature lower than a low temperature operating condition of the fuel cell.

5. The pressure sensor according to claim 1, wherein the first fluid is a liquid including ethylene-glycol and water.

6. The pressure sensor according to claim 1, wherein an electrical signal is generated and employed to monitor and adjust the pressure of the second fluid.

7. The pressure sensor according to claim 1, wherein the second fluid is one of a fuel, an oxidant, and a coolant.

8. The pressure sensor according to claim 1, wherein the fuel cell includes a communication path disposed between the flow channel and the pressure sensor, the communication path having:
a first membrane disposed adjacent a first end of the communication path; and
a second membrane disposed adjacent a second end of the communication path, the first membrane and the second membrane cooperating to seal the first fluid within the communication path.

9. The pressure sensor according to claim 8 having the first membrane of the communication path in contact with the second fluid and the second membrane of the communication path in contact with the membrane of the pressure sensor, wherein the first membrane, the first fluid, and the second membrane of the communication path are adapted to transfer the pressure of the second fluid from the flow channel to the pressure sensor.

10. A fuel cell comprising:
at least one pressure sensor including a body having a first end and a second end and including a cavity formed therein, the cavity adapted to contain a first fluid;
at least one flow channel adapted to provide a flow path for a second fluid, the second fluid being one of a fuel, an oxidant, and a coolant;
a communication path disposed between the flow channel and the pressure sensor, the communication path adapted to contain the first fluid and including at least one membrane disposed therein, the membrane separating the first fluid from the second fluid, wherein a pressure of the second fluid is transferred through the membrane and the first fluid to the pressure sensor.

11. The fuel cell according to claim 10, wherein the first fluid is a liquid having a freezing point at a temperature lower than a freezing point of water.

12. The fuel cell according to claim 10, wherein the first fluid is a liquid having a freezing point at a temperature lower than a low temperature operating condition of the fuel cell.

13. The fuel cell according to claim 10, wherein an electrical signal is generated by the pressure sensor and employed to monitor and adjust the pressure of the second fluid.

14. A fuel cell stack comprising:
at least one pressure sensor including a body having a first end and a second end and in fluid communication with a communication path adapted to contain a first fluid, wherein a pressure of a second fluid is transferred to the first fluid for monitoring by the pressure sensor; and
at least one fuel cell including at least one flow channel adapted to provide a flow path for the second fluid, the second fluid being one of a fuel, an oxidant, and a coolant.

15. The fuel cell stack according to claim 14, wherein the communication path has a first end and a second end, the first end including a cavity having one of a substantially conical shape, cubical shape, and cylindrical shape.

16. The fuel cell stack according to claim 14, wherein the pressure sensor is disposed within a structural member of the fuel cell stack.

17. The fuel cell stack according to claim 14, wherein the pressure sensor is disposed external to the fuel cell.

18. The fuel cell stack according to claim 14 wherein an electrical signal is generated by the pressure sensor and employed to adjust the pressure of the second fluid.
